(19) United States
(12) Patent Application Publication
(10) Pub. No.: US 2017/0168230 A1
(43) Pub. Date: Jun. 15, 2017

(54) DISPLAY DEVICE

(71) Applicant: Samsung Display Co., Ltd., Yongin-Si (KR)

(72) Inventors: Sang-chul BYUN, Anyang-si (KR); Hyuk-hwan KIM, Hwaseong-si (KR); Seokhyun NAM, Seoul (KR)

(21) Appl. No.: 15/269,210

(22) Filed: Sep. 19, 2016

(30) Foreign Application Priority Data
Dec. 9, 2015 (KR) 10-2015-0175275

(51) Int. Cl. F21V 8/00

(52) U.S. Cl. CPC G02B 6/0091

(57) ABSTRACT

A display device includes a backlight unit including a light guide plate including a light incident surface, an opposite surface facing the light incident surface, a light exit surface connecting the light incident surface and the opposite surface, and a light exit rear surface facing the light exit surface, a light source unit including a light source facing the light incident surface and a flexible printed circuit board disposed on a surface of the light source, a first coupling member disposed on a portion of the light exit rear surface, and a second coupling member disposed on a portion of the flexible printed circuit board, and a display panel disposed above the backlight unit where the first coupling member and the second coupling member are coupled to each other by a magnetic force.

This application claims priority to Korean Patent Application No. 10-2015-0175275, filed on Dec. 9, 2015, and all the benefits accruing therefrom under 35 U.S.C. §119, the content of which in its entirety is herein incorporated by reference.

### BACKGROUND

1. Field

Exemplary embodiments of the invention relate to a display device. More particularly, exemplary embodiments of the invention relate to a display device including a display panel and a backlight unit.

2. Description of the Related Art

In recent years, various displays, such as a liquid crystal display (“LCD”), a plasma display panel, an organic light emitting display, a field effect display, an electrophoretic display, etc., are widely used.

The LCD applied to various electronic devices, e.g., a television set, a mobile device, a monitor, etc., generally includes a liquid crystal panel which includes two substrates facing each other and a liquid crystal layer disposed between the two substrates, thereby displaying an image.

Since the LCD is not self-emissive, it is desired for the LCD to include a backlight unit including a light source to generate a light.

The backlight unit is classified into a direct-illumination type backlight unit and an edge-illumination type backlight unit according to a position of the light source of the backlight unit. In the direct-illumination type backlight unit, the light source is disposed under the liquid crystal panel and the light emitted from the light source is directly provided to the liquid crystal panel. In case of the edge-illumination type backlight unit, a light guide plate is disposed under the liquid crystal panel, and the light source is located at a side portion of the light guide plate. The light emitted from the light source is refracted and reflected by the light guide plate, and thus the light is indirectly provided to the liquid crystal panel.

### SUMMARY

Exemplary embodiments of the invention provide a display device which reduces a light leakage to prevent brightness from being lowered.

Exemplary embodiments of the invention provide a display device which reduces a light incident part of a light guide plate from being misaligned with a light source.

Exemplary embodiments of the invention provide a display device including a backlight unit and a display panel disposed above the backlight unit. The backlight unit may include a light guide plate including a light incident surface, an opposite surface facing the light incident surface, a light exit surface connecting the light incident surface and the opposite surface, and a light exit rear surface facing the light exit surface, a light source unit including a light source facing the light incident surface and a flexible printed circuit board disposed on a surface of the light source, a first coupling member disposed on a portion of the light exit rear surface, and a second coupling member disposed on a portion of the flexible printed circuit board. The first coupling member and the second coupling member may be coupled to each other by a magnetic force.

In an exemplary embodiment, one member of the first and second coupling members may be a magnet, and the other member of the first and second coupling members may be a magnet or a magnetic metal.

In an exemplary embodiment, the magnetic metal may include at least one of nickel, iron, cobalt, palladium, and an alloy thereof.

In an exemplary embodiment, the flexible printed circuit board may include a first sub-board part disposed under the light exit rear surface and a second sub-board part extending from the first sub-board part and facing the light incident surface. The second coupling member may be disposed on the first sub-board part, and the light source may contact the second sub-board part. In this case, the display device may further include a bottom chassis including a metal material. The bottom chassis may include a first sub-chassis part on which the first sub-board part and the light guide plate are placed and a second sub-chassis part extending from the first sub-chassis part and contacting the second sub-board part. The bottom chassis may further include a third sub-chassis part extending from the second sub-chassis part and facing a portion of the first sub-chassis part.

In an exemplary embodiment, the display device may further include a third coupling member disposed on a portion of the light exit surface.

In an exemplary embodiment, the first and third coupling members may partially overlap with each other in a plan view.

In an exemplary embodiment, the first and third coupling members may be spaced apart from each other in a plan view.

In an exemplary embodiment, the display device may further include a fourth coupling member disposed on a portion of the flexible printed circuit board and spaced apart from the second coupling member, and the third and fourth coupling members are coupled to each other by a magnetic force.

In an exemplary embodiment, the flexible printed circuit board may include a first sub-board part disposed under the light exit rear surface, a second sub-board part extending from the first sub-board part and facing the light incident surface, and a third sub-board part extending from the second sub-board part and facing a portion of the first sub-board part. The second coupling member may be disposed on the first sub-board part, the light source may contact the second sub-board part, and the fourth coupling member may contact the third sub-board part. In this case, the display device may further include a bottom chassis including a metal material. The bottom chassis may include a first sub-chassis part on which the first sub-board part and the light guide plate are placed, a second sub-chassis part extending from the first sub-chassis part and contacting the second sub-board part, and a third sub-chassis part extending from the second sub-chassis part and contacting the third sub-board part.

In an exemplary embodiment, the flexible printed circuit board may include a first area overlapping the light guide plate in a plan view and a second area non-overlapping the light guide plate in a plan view, the second coupling member is disposed in the first area, and the light source is disposed in the second area. In this case, the display device may further include a bottom chassis including a metal material. The bottom chassis includes a first sub-chassis part on which the flexible printed circuit board and the light guide plate are placed and a second sub-chassis part extending from the first sub-chassis part to cover the light source.

In an exemplary embodiment, the display device may further include a third coupling member disposed on a portion of the light exit surface, the bottom chassis may further include a third sub-chassis part extending from the second sub-chassis part and facing a portion of the first sub-chassis part, and the third coupling member and the third sub-chassis part are coupled to each other by a magnetic force.

In an exemplary embodiment, the flexible printed circuit board may include a first sub-board part disposed under the light exit rear surface and a second sub-board part extending from the first sub-board part and facing the light incident surface. The first sub-board part may include a first area overlapping the light guide plate in a plan view and a second area non-overlapping the light guide plate in a plan view, the second coupling member is disposed in the first area, and the light source is disposed in the second area. In this case, the display device may further include a bottom chassis including a metal material. The bottom chassis may include a first sub-chassis part on which the first sub-board part and the light guide plate are placed and a second sub-chassis part extending from the first sub-chassis part and contacting the second sub-board part. The bottom chassis may further include a third sub-chassis part extending from the second sub-chassis part and facing a portion of the first sub-chassis part. In this case, the display device may further include a third coupling member disposed on a portion of the light exit surface, and the third coupling member and the third sub-chassis part are coupled to each other by a magnetic force.

In an exemplary embodiment, the flexible printed circuit board may further include a third sub-board part extending from the second sub-board part and facing a portion of the first sub-board part. In this case, the display device may further include a third coupling member disposed on a portion of the light exit surface and a fourth coupling member contacting the third sub-board part. The third and fourth coupling members may be coupled to each other by a magnetic force.

According to the above, the light incident surface of the light guide plate and the light source may be prevented from being misaligned with each other.

According to the above, the light leakage may be prevented from leaking, and thus the brightness may be prevented from being lowered.

### BRIEF DESCRIPTION OF THE DRAWINGS

The above and other advantages of the invention will become readily apparent by reference to the following detailed description when considered in conjunction with the accompanying drawings wherein:

FIG. 1A is a perspective view showing an exemplary embodiment of a display device according to the invention;

FIG. 1B is a perspective view showing an exemplary embodiment of a display device according to the invention;

FIG. 1C is a cross-sectional view taken along line A-A′ shown in FIGS. 1A and 1B;

FIG. 2A is a perspective view showing an exemplary embodiment of a display device according to the invention;

FIG. 2B is a cross-sectional view taken along line B-B′ shown in FIG. 2A;

FIG. 3A is a perspective view showing an exemplary embodiment of a display device according to the invention;

FIG. 3B is a cross-sectional view taken along line C-C′ shown in FIG. 3A;

FIG. 4A is a perspective view showing an exemplary embodiment of a display device according to the invention;

FIG. 4B is a cross-sectional view taken along line D-D′ shown in FIG. 4A;

FIG. 4C is a cross-sectional view showing a modified example of the display device shown in FIG. 4B;

FIG. 5A is a perspective view showing an exemplary embodiment of a display device according to the invention;

FIG. 5B is a cross-sectional view taken along line E-E′ shown in FIG. 5A;

FIG. 6A is a perspective view showing an exemplary embodiment of a display device according to the invention;

FIG. 6B is a cross-sectional view taken along line F-F′ shown in FIG. 6A;

FIG. 7A is a perspective view showing an exemplary embodiment of a display device according to the invention;

FIG. 7B is a cross-sectional view taken along line G-G′ shown in FIG. 7A;

FIG. 8A is a perspective view showing an exemplary embodiment of a display device according to the invention;

FIG. 8B is a cross-sectional view taken along line H-H′ shown in FIG. 8A;

FIG. 9A is a perspective view showing an exemplary embodiment of a display device according to the invention;

FIG. 9B is a cross-sectional view taken along line I-I′ shown in FIG. 9A;

FIG. 10A is a perspective view showing an exemplary embodiment of a display device according to the invention;

FIG. 10B is a cross-sectional view taken along line J-J′ shown in FIG. 10A;

FIG. 11A is a perspective view showing an exemplary embodiment of a display device according to the invention;

FIG. 11B is a cross-sectional view taken along line K-K′ shown in FIG. 11A;

FIG. 12A is a perspective view showing an exemplary embodiment of a display device according to the invention;

FIG. 12B is a cross-sectional view taken along line L-L′ shown in FIG. 12A;

FIG. 13A is a perspective view showing an exemplary embodiment of a display device according to the invention; and

FIG. 13B is a cross-sectional view taken along line M-M′ shown in FIG. 13A.

### DETAILED DESCRIPTION

The following description with reference to the accompanying drawings is provided to assist in a comprehensive understanding of various embodiments of the invention as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the invention.

Like numerals refer to like elements throughout. In the drawings, the thickness of layers, films, and regions are exaggerated for clarity. The use of the terms first, second, etc. do not denote any order or importance, but rather the terms first, second, etc. are used to distinguish one element from another. It will be understood that when an element such as a layer, film, region, or substrate is referred to as being “on” another element, it can be directly on the other element or intervening elements may also be present. It is to be understood that the singular forms “a”, “an,” and “the” include plural referents unless the context clearly dictates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus. “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, the invention will be explained in detail with reference to the accompanying drawings.

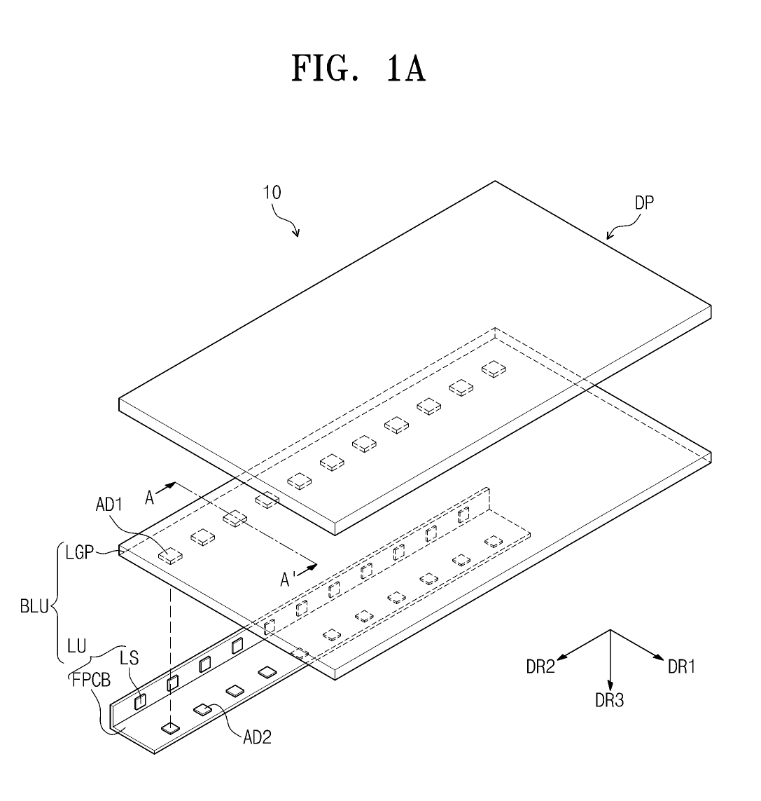

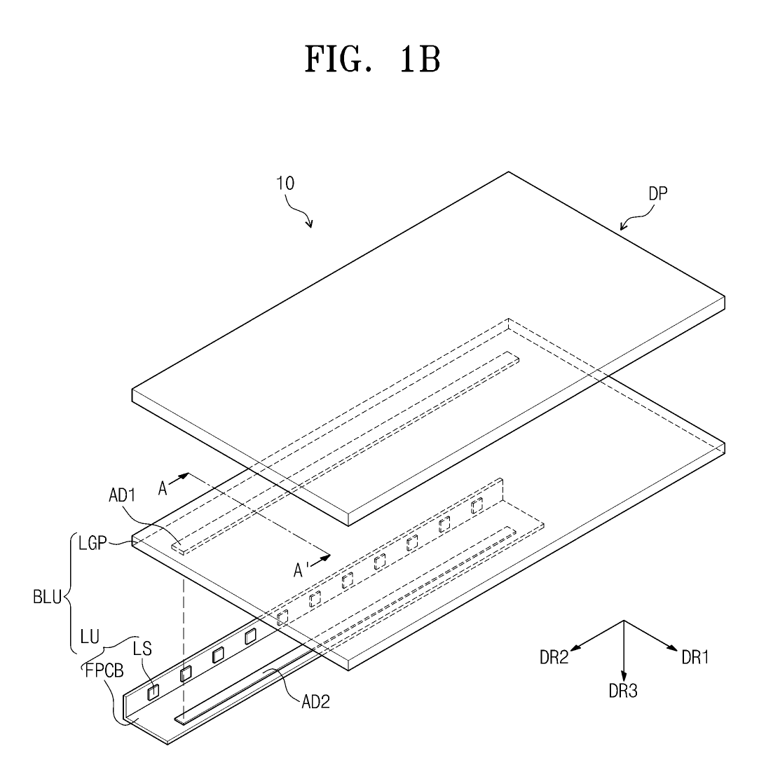

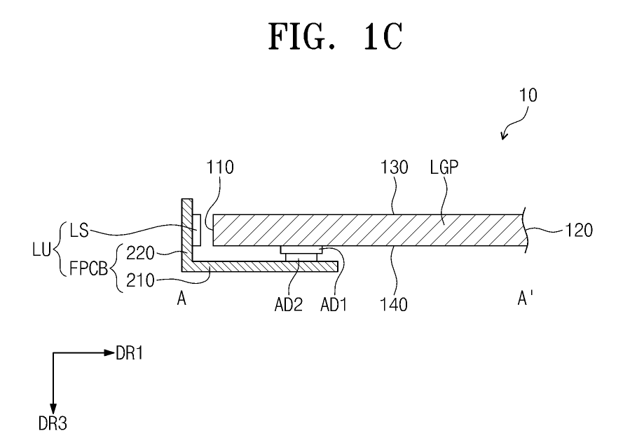

FIG. 1A is a perspective view showing a display device 10 according to an exemplary embodiment of the invention, and FIG. 1B is a perspective view showing a display device 10 according to an exemplary embodiment of the invention.

Referring to FIGS. 1A and 1B, the display device 10 includes a backlight unit BLU and a display panel DP disposed on the backlight unit BLU.

The display panel DP is disposed above the backlight unit BLU to be spaced apart from the backlight unit BLU. In an exemplary embodiment, the display panel DP may be, but not limited to, a liquid crystal display (“LCD”) panel or an electrophoretic display panel. Hereinafter, the LCD panel will be described as the display panel, for example.

The backlight unit BLU includes a light guide plate LGP and a light source unit LU. Although not shown in figures, an optical member may be disposed between the light guide plate LGP and the display panel DP. The optical member improves a brightness and a viewing angle of a light exiting through a light exit surface 130 (refer to FIG. 1C) of the light guide plate LGP. The optical member may include first, second, and third optical members sequentially stacked one on another.

In an exemplary embodiment, the first optical member may be, but not limited to, a diffusion sheet to diffuse the light exiting from the light guide plate LGP, for example. In an exemplary embodiment, the second optical member may be, but not limited to, a prism sheet to condense the light diffused by the diffusion sheet in a direction substantially perpendicular to a plane of the display panel DP disposed above on the prism sheet, for example. In an exemplary embodiment, the third optical member may be, but not limited to, a protective sheet to protect the prism sheet from external impacts, for example. At least one of the first, second, and third optical members may be provided in plural number, or one or more of the first, second, and third optical members may be omitted from the optical member.

The structure of the optical member should not be limited to the above-mentioned structure.

Although not shown in figures, the backlight unit BLU may further include a reflective sheet. The reflective sheet is disposed under the light guide plate LGP. The reflective sheet reflects a light leaked from the light guide plate LGP without being directed to the display panel DP to allow the leaked light to travel to the display panel DP. Accordingly, the reflective sheet increases an amount of the light provided to the display panel DP.

The light source unit LU includes a light source LS and a flexible printed circuit board FPCB disposed on one surface of the light source LS. The light source LS is disposed (e.g., mounted) on one surface of the flexible printed circuit board FPCB by using commonly known in the art. The flexible printed circuit board FPCB applies a power source voltage to the light source LS. The flexible printed circuit board FPCB may include a flexible resin layer to have a flexibility. The flexible printed circuit board FPCB will be described in detail later.

In an exemplary embodiment, the light source LS may be, but not limited to, a light emitting diode (“LED”). The light source LS may be provided in a plural number, and the light sources LS may be arranged on the flexible printed circuit board FPCB in a second direction DR2 to be spaced apart from each other. In an exemplary embodiment, the light source unit LU included in the display device 10 according to the exemplary embodiment may be, but not limited to, an LED chip or an LED package, for example. In an exemplary embodiment, each of the LEDs may be disposed in a case that serves as a housing, for example.

FIG. 1C is a cross-sectional view taken along line A-A′ shown in FIGS. 1A and 1B. Referring to FIG. 1C, the light guide plate LGP includes a light incident surface 110, an opposite surface 120, the light exit surface 130, and a light exit rear surface 140. The opposite surface 120 faces the light incident surface 110. The opposite surface 120 is spaced apart from the light incident surface 110 in a first direction DR1 and faces the light incident surface 110. The light exit surface 130 connects the light incident surface 110 and the opposite surface 120. The light exit surface 130 connects one end of the light incident surface and one end of the opposite surface. The light incident to the light guide plate LGP from the light source unit LU exits through the light exit surface 130 to the display panel DP. The light exit rear surface 140 faces the light exit surface 130. The light exit rear surface 140 is spaced apart from the light exit surface 130 in a third direction DR3 and faces the light exit surface 130. The light exit rear surface 140 connects the other end of the light incident surface 110 and the other end of the opposite surface 120.

The light source LS faces the light incident surface 110 of the light guide plate LGP. The light source LS is provided to allow a light emitting surface thereof to face the light incident surface 110 of the light guide plate LGP.

The backlight unit BLU further includes a first coupling member AD1 and a second coupling member AD2. The first coupling member AD1 is disposed on a portion of the light exit rear surface 140 of the light guide plate LGP. The light exit rear surface 140 is divided into an area (not shown) in which the first coupling member AD1 is disposed and an area (not shown) in which the first coupling member AD1 is not disposed. The first coupling member AD1 may serve as a light blocking member. In this case, a light blocking member among optical members, which is disposed between the light guide plate LGP and the display panel DP to prevent a light leakage from occurring, may be omitted.

Referring to FIG. 1A, the first coupling member AD1 may be provided in a plural number, and the first coupling members AD1 are arranged on the light exit rear surface 140 to be spaced apart from each other. In an exemplary embodiment, the first coupling members AD1 are arranged on portions of the light exit rear surface 140 along a second direction DR2 and spaced apart from each other, for example.

Referring to FIG. 1B, the first coupling member AD1 may be provided on a portion of the light exit rear surface 140 to have a substantially rectangular shape, for example. In this case, the first coupling member AD1 is provided in a singular number. In an exemplary embodiment, the first coupling member AD1 has a shape extending in the second direction DR2 and is provided as a single unitary structure, for example. It may be easier to provide a single unitary first coupling member AD1 extending in the second direction DR2 than providing a plurality of first coupling members AD1 spaced apart from each other in the second direction DR2.

The second coupling member AD2 is disposed on a portion of the flexible printed circuit board FPCB. The second coupling member AD2 is disposed on the flexible printed circuit board FPCB and spaced apart from the light source LS.

Referring to back FIG. 1A, the second coupling member AD2 may be provided in a plural number, and the second coupling member AD2 are spaced apart from each other. That is, the second coupling members AD2 are arranged on the flexible printed circuit board FPCB in the second direction DR2 and spaced apart from each other. In detail, in the case where the light sources LS are arranged on the flexible printed circuit board FPCB along the second direction DR2 and spaced apart from each other, the second coupling members AD2 are spaced apart from each light source LS, and in addition, the second coupling members AD2 are spaced apart from each other in the second direction DR2.

Referring back to FIG. 1B, the second coupling member AD2 is provided on a portion of the flexible printed circuit board FPCB and has a substantially rectangular shape, for example. In this case, the second coupling member AD2 may be provided in a singular number. For instance, the second coupling member AD2 is disposed on the flexible printed circuit board FPCB, extends in the second direction DR2, and is integrally provided as a single unitary structure. In the case where the second coupling member AD2 extends in the second direction DR2 and has a single unitary structure, it is advantageous to easily form the second coupling member AD2 as compared with the case where the second coupling members AD2 are provided in the second direction DR2 to be spaced apart from each other.

Although not shown in FIGS. 1A and 1B, according to embodiments, the first coupling members AD1 may be provided to be spaced apart from each other in the second direction DR2, and the second coupling member AD2 may be provided to have the single unitary structure extending in the second direction DR2. As another example, the first coupling member AD1 may be provided to have the single unitary structure extending in the second direction DR2, and the second coupling members AD2 may be provided to be spaced apart from each other in the second direction DR2 according to embodiments. However, it is advantageous that each of the first and second coupling members AD1 and AD2 is provided to have the single unitary structure extending in the second direction DR2 in terms of ease of work, but it should not be limited thereto or thereby.

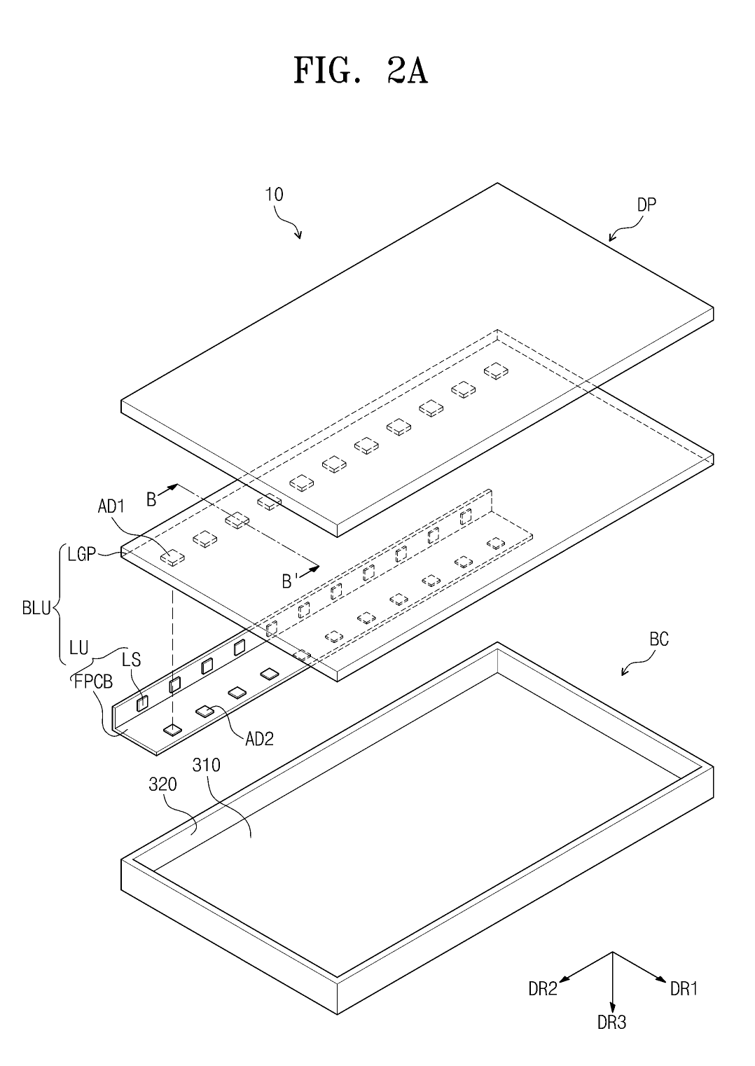

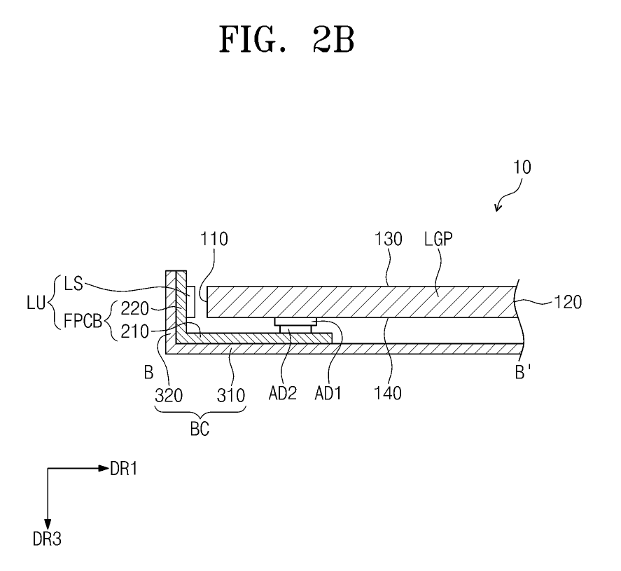

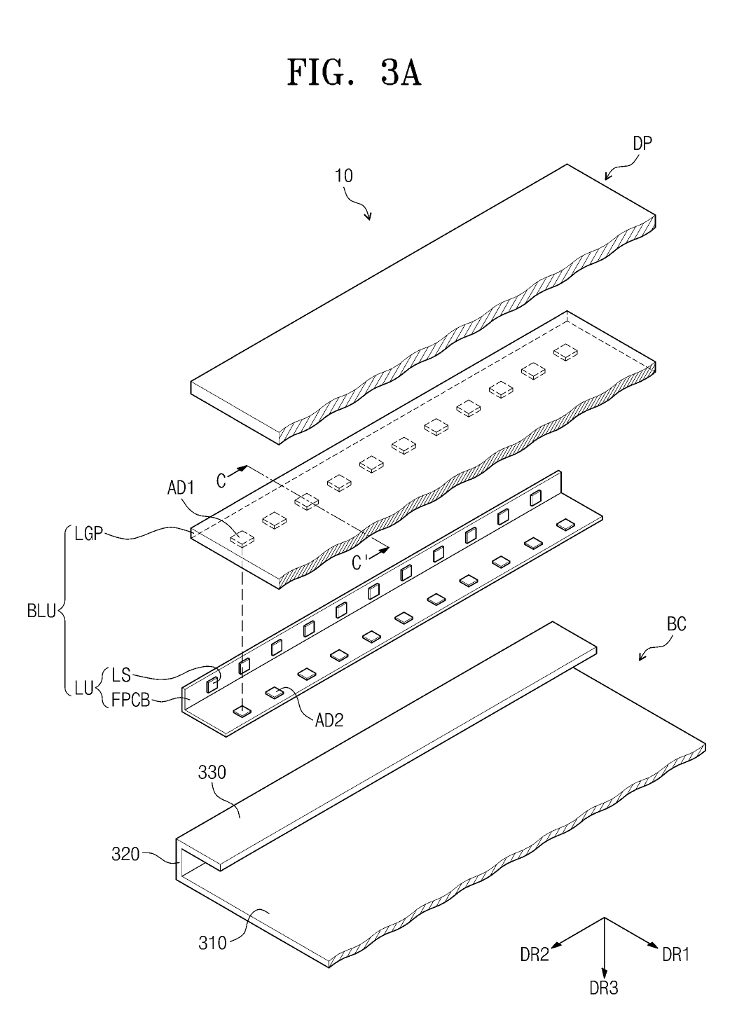

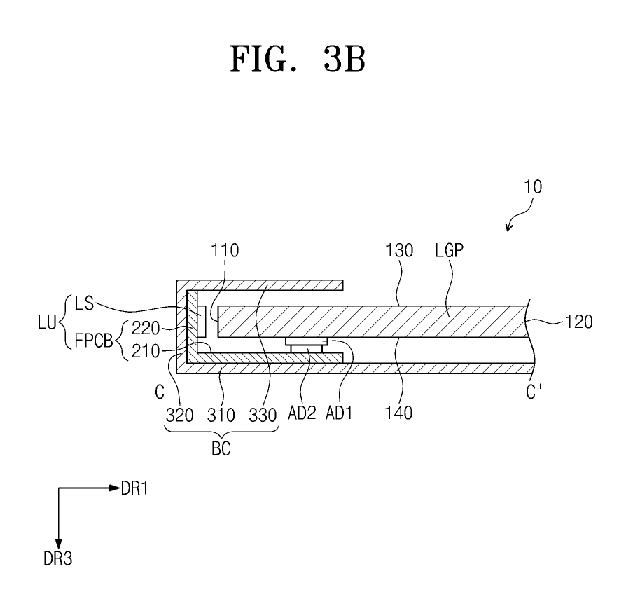

In FIGS. 2A and 3A described later, each of the first and second coupling members AD1 and AD2 is provided in a plural number and arranged in the second direction DR2 to be spaced apart from each other, but it should not be limited thereto or thereby. That is, each of the first and second coupling members AD1 and AD2 may be provided to have the single unitary structure extending in the second direction DR2.

Referring back to FIG. 1C, the first coupling member AD1 and the second coupling member AD2 are coupled to each other by a magnetic force. The first and second coupling members AD1 and AD2 are magnetically coupled to each other.

To couple the first coupling member AD1 to the second coupling member AD2 using the magnetic force, the first and second coupling members AD1 and AD2 are desired to include a material having a magnetic force.

One of the first and second coupling members AD1 and AD2 is a magnet and the other of the first and second coupling members AD1 and AD2 is a magnet or a magnetic metal. In the illustrated exemplary embodiment, the first coupling member AD1 is the magnet and the second coupling member AD2 is the magnetic metal. On the contrary, the first coupling member AD1 may be the magnetic metal and the second coupling member AD2 may be the magnet according to embodiments. The term “magnetic metal” used herein may indicate metals exhibiting magnetism.

In an exemplary embodiment, the magnetic metal may be a ferromagnet, for example, but it should not be limited thereto or thereby. The magnetic metal may be selected from the one commonly known in the art without limitation. In an exemplary embodiment, the magnetic metal may include at least one of nickel, iron, cobalt, palladium, and an ally thereof, for example. In the illustrated exemplary embodiment, the magnetic metal may include nickel, for example.

The first coupling member AD1 should not be limited to a specific material as long as the material included in the first coupling member AD1 has the magnetic force. In addition, since the first coupling member AD1 is attached to the light exit rear surface 140, a surface of the first coupling member AD1, which contacts the light exit rear surface 140, is desired to have a predetermined adhesive force. In general, since the light guide plate LGP does not have the magnetic force, the adhesive force of the surface of the first coupling member AD1, which contacts the light exit rear surface 140, has an adhesive force corresponding to its own adhesive force other than the adhesive force by the magnetic force. In an exemplary embodiment, the first coupling member AD1 may have a tape shape, but it should not be limited thereto or thereby.

The first coupling member AD1 may include adhesive material commonly known in the art. In an exemplary embodiment, the first coupling member AD1 may include at least one of an acrylate-based resin, a silicon-based resin, an epoxy-bases resin, and an urethane-based resin, for example. As described above, the first coupling member AD1 is desired to have the magnetic force for the coupling with the second coupling member AD2. Although not shown in figures, the first coupling member AD1 may include an adhesive layer and a magnetic layer disposed on the adhesive layer, the adhesive layer may directly contact the light exit rear surface 140, and the magnetic layer may directly contact the second coupling member AD2. The magnetic layer may be provided in a magnetic sheet. However, the first coupling member AD1 should not be limited to a specific structure as long as the first coupling member AD1 has the adhesive force that is enough to be coupled to the light exit rear surface 140 and the magnetic force that is enough to be coupled to the second coupling member AD2. The second coupling member AD2 should not be limited to a specific material as long as the material included in the second coupling member AD2 has the magnetic force. The second coupling member AD2 may be provided by plating the magnetic metal on the flexible printed circuit board FPCB. In an exemplary embodiment, the second coupling member AD2 may include at least one of nickel, iron, cobalt, palladium, and an alloy thereof, for example. In an exemplary embodiment, the second adhesive member may be, but not limited to, a nickel plating layer, for example.

In FIG. 1C, a width of the first coupling member AD1 along the first direction DR1 is greater than a width of the second coupling member AD2 along the first direction DR1, but it should not be limited thereto or thereby. For instance, the width of the first coupling member AD1 may be substantially equal to the width of the second coupling member AD2, or the width of the second coupling member AD2 may be greater than the width of the first coupling member AD1. Hereinafter, the term “width” used herein means a length in the first direction DR1.

In FIG. 1B, a thickness of the first coupling member AD1 taken along the second direction DR2 is equal to a thickness of the second adhesive member AD2 the second direction DR2, but it should not be limited thereto or thereby. In an exemplary embodiment, the thickness of the first coupling member AD1 may be greater than the thickness of the second adhesive member AD2, or the thickness of the second coupling member AD2 may be greater than the thickness of the first adhesive member AD1, for example. Hereinafter, the term “thickness” used herein means a length in the second direction DR2.

In a conventional light guide plate, a light incident surface of the light guide plate is greater in size than a light source, but the light incident surface of the light guide plate is desired to be equal to the surface of the light source, which faces the light incident surface, since demand for thin display device keeps on increasing in the market. In the case where the light incident surface of the light guide plate is controlled to be equal to the surface of the light source, which faces the light incident surface, the light source unit might be misaligned with the light guide plate, and thus the light leakage occurs. As a result, the brightness of the light guide plate is lowered. According to the display device of the invention, the light guide plate and the flexible printed circuit board are securely coupled to each other by the coupling members respectively disposed on the light guide plate and the flexible printed circuit board, so that the misalignment between the light guide plate and the light source unit may be reduced.

The flexible printed circuit board FPCB includes a first sub-board part 210 and a second sub-board part 220. The first sub-board part 210 and the second sub-board part 220 may be integrally provided with each other as a single unitary structure. In an exemplary embodiment, the flexible printed circuit board FPCB may have an L-shape in a cross-section, for example.

The first sub-board part 210 is disposed under the light exit rear surface 140. A portion of the first sub-board part 210 overlaps a portion of the light exit rear surface 140 in a plan view. The second coupling member AD2 is disposed on the first sub-board part 210.

In the description, the term “a plan view” used herein means a view (e.g., top or bottom view) of the display device 10 projected onto a plane defined by the first direction DR1 and the second direction DR2.

The second sub-board part 220 extends from the first sub-board part 210 to face the light incident surface 110. The second sub-board part 220 extends from the first sub-board part 210 in a perpendicular direction. The second sub-board part 220 contacts the light source LS. The light source LS is disposed between the second sub-board part 220 and the light guide plate LGP. The light guide plate LGP is spaced apart from the second sub-board part 220 in the first direction DR1.

FIG. 2A is a perspective view showing a display device 10 according to an exemplary embodiment of the invention.

Referring to FIG. 2A, the display device 10 may further include a bottom chassis BC. The bottom chassis BC accommodates components of the backlight unit BLU and the display panel DP. The bottom chassis BC includes a material having the magnetic force. The bottom chassis BC includes a metal material. The bottom chassis BC includes the metal material having the magnetic force. The bottom chassis BC includes the metal material including stainless steel, galvalume, or aluminum.

Although not shown in figures, the display device 10 may further include a mold frame. The mold frame is disposed between the display panel DP and the backlight unit BLU. The mold frame is provided along an edge of the display panel DP and disposed under the display panel DP to support the display panel DP.

FIG. 2B is a cross-sectional view taken along line B-B′ shown in FIG. 2A.

Referring to FIG. 2B, the bottom chassis BC includes a first sub-chassis part 310 and a second sub-chassis part 320. The first sub-chassis part 310 and the second sub-chassis part 320 are integrally provided with each other as a single unitary structure.

The first sub-board part 210 and the light guide plate LGP are placed on the first sub-chassis part 310. The first sub-board part 210 makes contact with the first sub-chassis part 310. The light guide plate LGP may be spaced apart from the first sub-chassis part 310, but the invention is not limited thereto, and the light guide plate LGP may contact the first sub-chassis part 310. In the case where the light guide plate LGP is spaced apart from the first sub-chassis part 310, the above-mentioned reflective sheet (not shown) may be disposed between the light guide plate LGP and the first sub-chassis part 310. The reflective sheet (not shown) contacts the first sub-chassis part 310.

The second sub-chassis part 320 extends from the first sub-chassis part 310 and contacts the second sub-board part 220. The second sub-chassis part 320 extends from the first sub-chassis part 310 in a perpendicular direction. The bottom chassis BC has an L-shape in a cross-section.

The light guide plate LGP and the light source unit LU may more effectively be prevented from being misaligned with each other by the bottom chassis BC.

FIG. 3A is a perspective view showing a display device 10 according to an exemplary embodiment of the invention, and FIG. 3B is a cross-sectional view taken along line C-C′ shown in FIG. 3A.

Referring to FIGS. 3A and 3B, a bottom chassis BC may further include a third sub-chassis part 330. The third sub-chassis part 330 extends from the second sub-chassis part 320. The third sub-chassis part 330 extends from the second sub-chassis part 320 in the first direction DR1. The third sub-chassis part 330 is substantially parallel to a portion of the first sub-chassis part 310. The third sub-chassis part 330 overlaps a portion of the first sub-chassis part 310 in a plan view. In the case where the bottom chassis BC further includes the third sub-chassis part 330, the first sub-chassis part 310 includes an area overlapping the third sub-chassis part 330 in a plan view and area non-overlapping the third sub-chassis part 330 in a plan view. The two areas are adjacent to each other. In the case where the bottom chassis BC further includes the third sub-chassis part 330, the bottom chassis BC has a laid U-shape in a cross-section. The first, second, and third sub-chassis parts 310, 320, and 330 may be integrally provided with each other as a single unitary structure.

Although not shown in FIGS. 3A and 3B, the display device 10 according to the exemplary embodiment may include a third coupling member disposed on a portion of the light exit surface 130, and the third coupling member and the third sub-chassis part 330 may be coupled to each other by the magnetic force. Accordingly, the light guide plate LGP and the light source unit LU may be prevented from being misaligned with each other. It is preferred that a surface of the third coupling member, which contacts the light exit surface 130, has an adhesive force corresponding to its own adhesive force other than the adhesive force caused by the magnetic force. The third coupling member will be described in detail later.

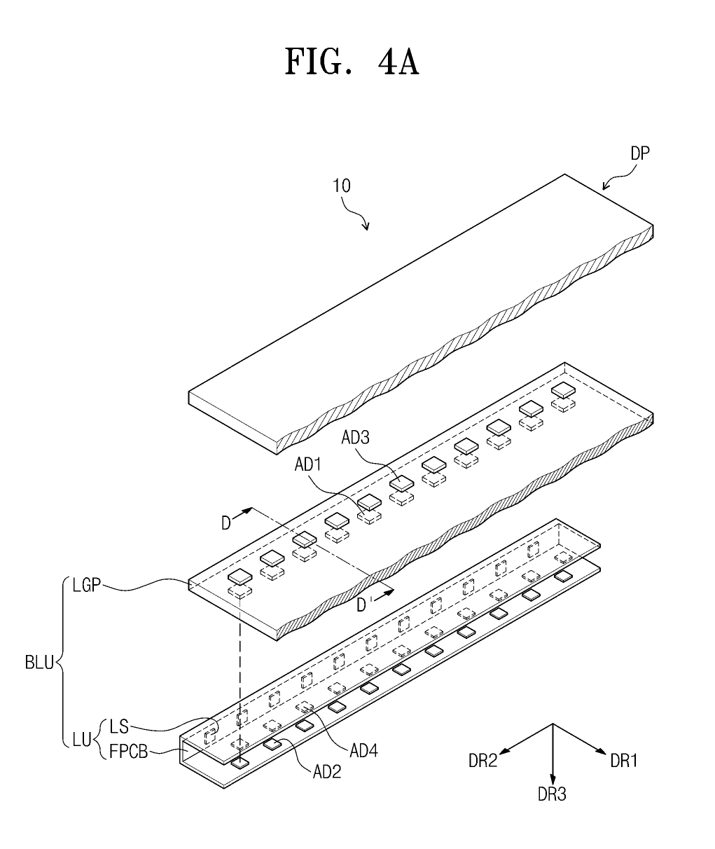

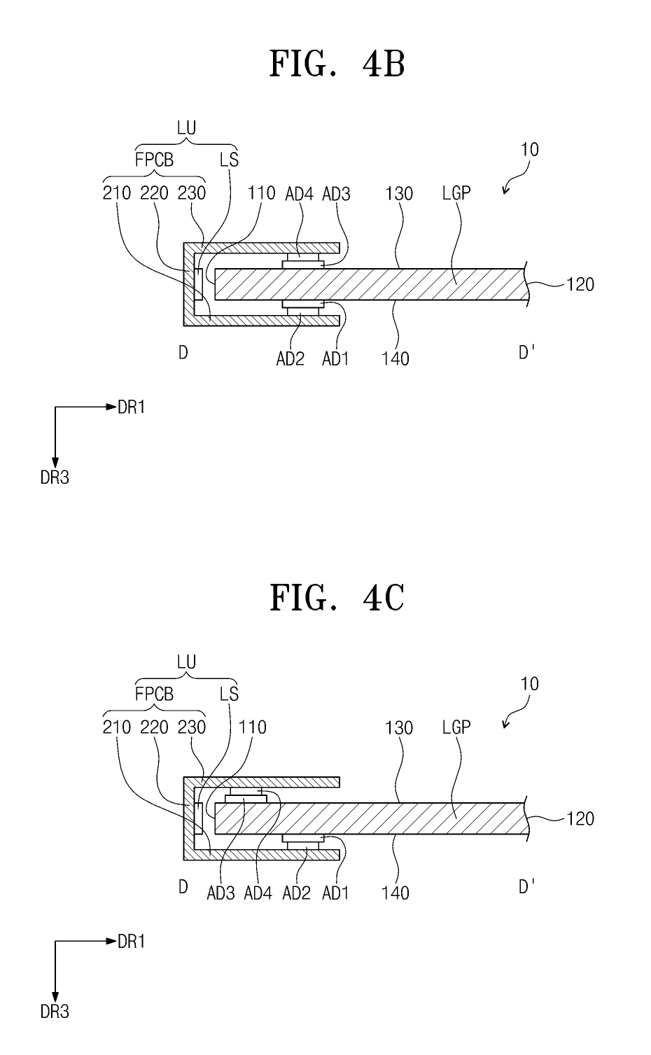

FIG. 4A is a perspective view showing a display device 10 according to an exemplary embodiment of the invention, and FIG. 4B is a cross-sectional view taken along line D-D′ shown in FIG. 4A,

Referring to FIGS. 4A and 4B, the display device 10 may further include a third coupling member AD3. The third coupling member AD3 is disposed on a portion of the light exit surface 130 of the light guide plate LGP.

At least a portion of the first coupling member AD1 overlaps at least a portion of the third coupling member AD3 in a plan view, but it should not be limited thereto or thereby. That is, the first coupling member AD1 may have a width (not shown) taken along the first direction DR1 substantially equal to or different from a width of the third coupling member AD3 taken along the first direction DR1. The first coupling member AD1 may have a thickness (not shown) taken along the second direction DR2 substantially equal to or different from a thickness of the third coupling member AD3 taken along the second direction DR2.

FIG. 4C is a cross-sectional view showing a modified example of the display device shown in FIG. 4B.

Referring to FIG. 4C, the first coupling member AD1 and the third coupling member AD3 are spaced apart from each other in a plan view. The first coupling member AD1 and the third coupling member AD3 do not overlap each other in a plan view.

The display device 10 may further include a fourth coupling member AD4. The fourth coupling member AD4 is disposed on a portion of the flexible printed circuit board FPCB and spaced apart from the second coupling member AD2.

The third and fourth coupling members AD3 and AD4 are coupled to each other by the magnetic force. The third and fourth coupling members AD3 and AD4 are magnetically coupled to each other.

The third coupling member AD3 has the same structure and function as those of the first coupling member AD1 except for the position of the third coupling member AD3, and thus details of the third coupling member AD3 will not be provided. In an exemplary embodiment, the third coupling member AD3 may have a tape shape, for example.

The fourth coupling member AD4 has the same structure and function as those of the second coupling member AD2 except for the position of the fourth coupling member AD4, and thus details of the fourth coupling member AD4 will not be provided.

Referring to FIGS. 4A to 4C, the flexible printed circuit board FPCB may further include a third sub-board part 230 in addition to the first and second sub-board parts 210 and 220. The third sub-board part 230 extends from the second sub-board part 220. The third sub-board part 230 extends from the second sub-board part 220 in the first direction DR1. The first and third sub-board parts 210 and 230 are substantially parallel to each other. The first and third sub-board parts 210 and 230 overlap each other. The first sub-board part 210 has a width, e.g., a length in the first direction DR1, substantially equal to or different from a width, e.g., a length in the first direction DR1, of the third sub-board part 230.

In the case where the flexible printed circuit board FPCB further includes the third sub-board part 230, the flexible printed circuit board FPCB has a laid U-shape in a cross-section. The first, second, and third sub-board parts 210, 220, and 230 may be integrally provided with each other as a single unitary structure.

The fourth coupling member AD4 contacts the third sub-board part 230. The fourth coupling member AD4 contacts a portion of the third sub-board part 230. The third sub-board part 230 includes an area (not shown) overlapping the fourth coupling member AD4 and an area (not shown) non-overlapping the fourth coupling member AD4 in a plan view, and the two areas are adjacent to each other.

The display device according to the exemplary embodiment further includes the third and fourth coupling members AD3 and AD4 coupled to each other by the magnetic force, and thus the light guide plate LGP and the light source unit LU may be more effectively prevented from being misaligned with each other.

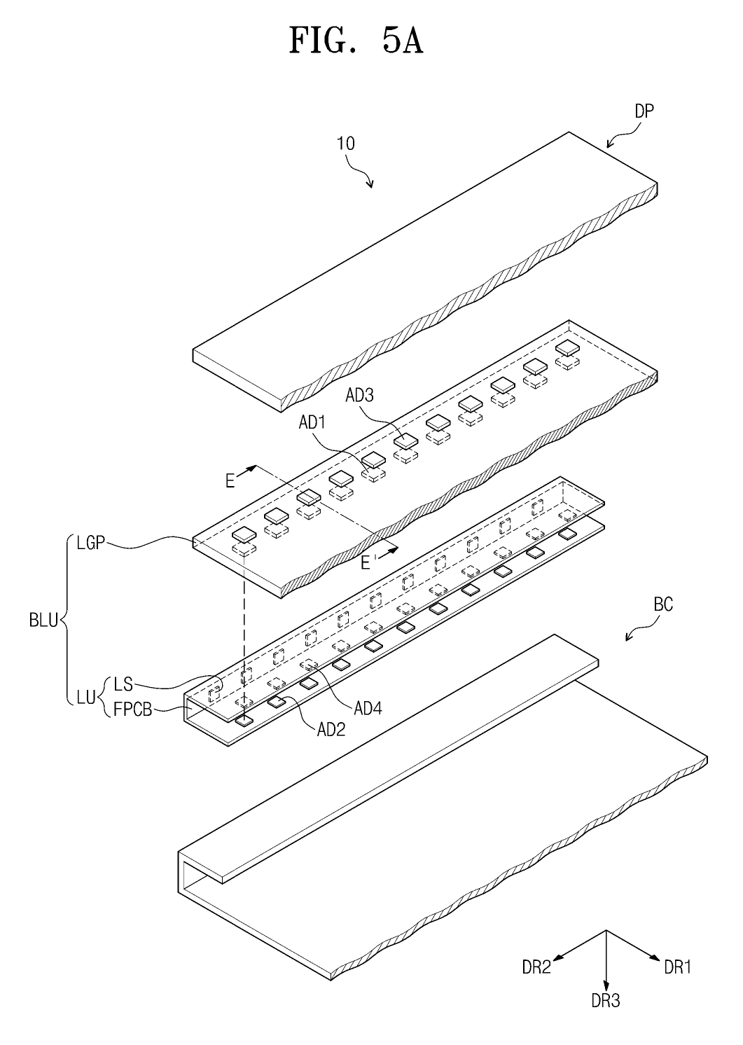

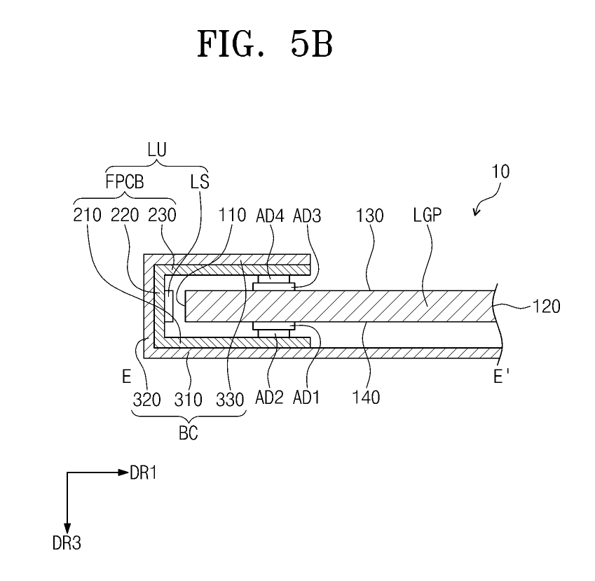

FIG. 5A is a perspective view showing a display device 10 according to an exemplary embodiment of the invention, and FIG. 5B is a cross-sectional view taken along line E-E′ shown in FIG. 5A.

Referring to FIGS. 5A and 5B, in the case where the bottom chassis BC further includes the third sub-chassis part 330, the third sub-chassis part 330 may contact the third sub-board part 230. The third sub-board part 230 has the above-mentioned structure and function, and thus details thereof will not be provided.

The first coupling member AD1 disposed on the portion of the light exit rear surface 140 of the light guide plate LGP is securely coupled to the second coupling member AD2 disposed on the first sub-board part 210 of the flexible printed circuit board FPCB by the magnetic force, and the third coupling member AD3 disposed on the portion of the light exit surface 130 of the light guide plate LGP is securely coupled to the fourth coupling member AD4 contacting the third sub-board part 230 of the flexible printed circuit board FPCB. Therefore, the light source unit LU and the light guide plate LGP may effectively be prevented from being misaligned with each other. In addition, since the bottom chassis BC which includes the first sub-chassis part 310 on which the first sub-board part 210 and the light guide plate LGP are placed, the second sub-chassis part 320 contacting the second sub-board part 220, and the third sub-chassis part 330 contacting the third sub-board part 230 is further included in the display device 10, the misalignment between the light source unit LU and the light guide plate LGP may be more effectively prevented.

FIGS. 1A to 5B shows a top view type light source unit as the light source unit LU, but the light source unit LU may be a side view type light source unit. Hereinafter, a display device 10 including the side view type light source unit will be described.

In a conventional top view type light source unit, a flexible printed circuit board having a width greater than that of a light source is used, so that the light source unit is difficult to be applied to a thin-type structure. However, in the display device 10 of the invention, the top view type light source unit LU may be applied to the thin-type structure since the portion of the flexible printed circuit board FPCB is folded to the upper and/or lower position the light guide plate LGP. In detail, the structure in which the flexible printed circuit board FPCB includes the first sub-board part 210 and the second sub-board part 220 and the structure in which the flexible printed circuit board FPCB includes the first to third sub-board parts 210 to 230 correspond to the above-mentioned structure allowing the top view type light source unit LU to be applied to the thin-type structure.

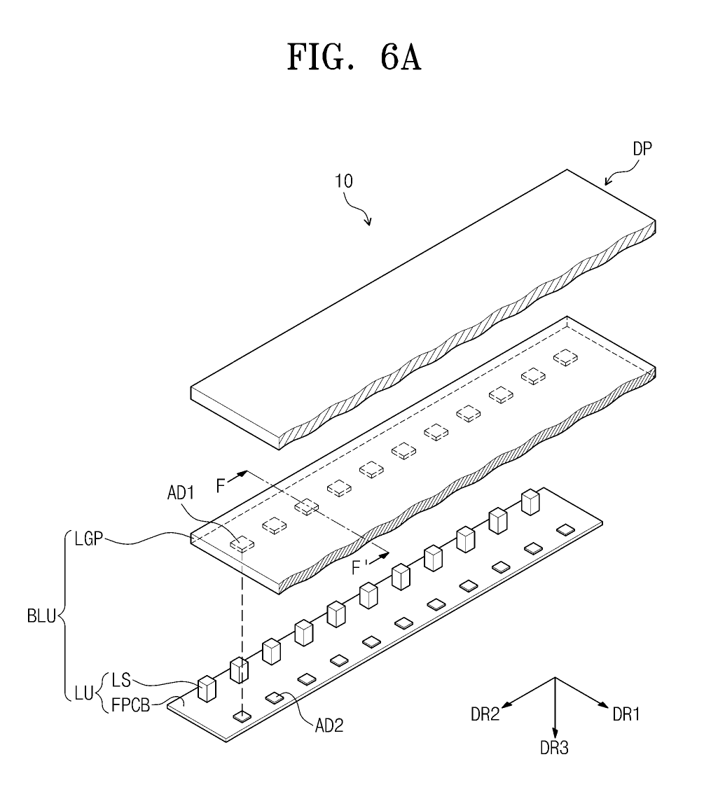

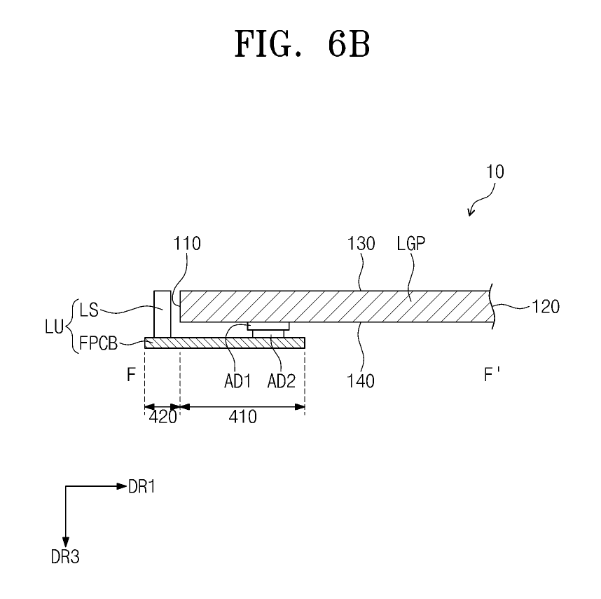

FIG. 6A is a perspective view showing a display device 10 according to an exemplary embodiment of the invention and FIG. 6B is a cross-sectional view taken along line F-F′ shown in FIG. 6A.

Referring to FIGS. 6A and 6B, a flexible printed circuit board FPCB includes a first area 410 overlapping the light guide plate LGP and a second area 420 non-overlapping the light guide plate LGP in a plan view. The first and second areas 410 and 420 are integrally provided with each other as a single unitary structure. The first coupling member AD2 is disposed in the first area 410. The second coupling member AD2 is disposed between the first area 410 and the light exit rear surface 140. The light source LS is disposed in the second area 420. The light source LS and the second coupling member AD2 are disposed on the flexible printed circuit board FPCB and spaced apart from each other.

In a conventional display device, a light guide plate and a flexible printed circuit board are fixed to each other using a tape having the adhesive force. However, in the display device 10 according to the exemplary embodiment, the first coupling member AD1 is disposed on the portion of the light exit rear surface 140 of the light guide plate LGP, and the second coupling member AD2 is disposed on the flexible printed circuit board FPCB. The first and second coupling members AD1 and AD2 are securely coupled with each other by the magnetic force, and thus the light guide plate LGP and the flexible printed circuit board FPCB may be more effectively fixed to each other. Consequently, the light incident surface 110 of the light guide plate LGP and the light source LS may be prevented from being misaligned with each other.

In FIG. 6B, for the convenience of explanation, a length in the third direction DR3 of the surface of the light source LS, which faces the light incident surface 110, is greater than a length in the third direction DR3 of the light incident surface 110 of the light guide plate LGP. However, the length in the third direction DR3 of the light incident surface 110 of the light guide plate LGP is desired to be substantially equal to the length in the third direction DR3 of the surface of the light source LS, which faces the light incident surface 110.

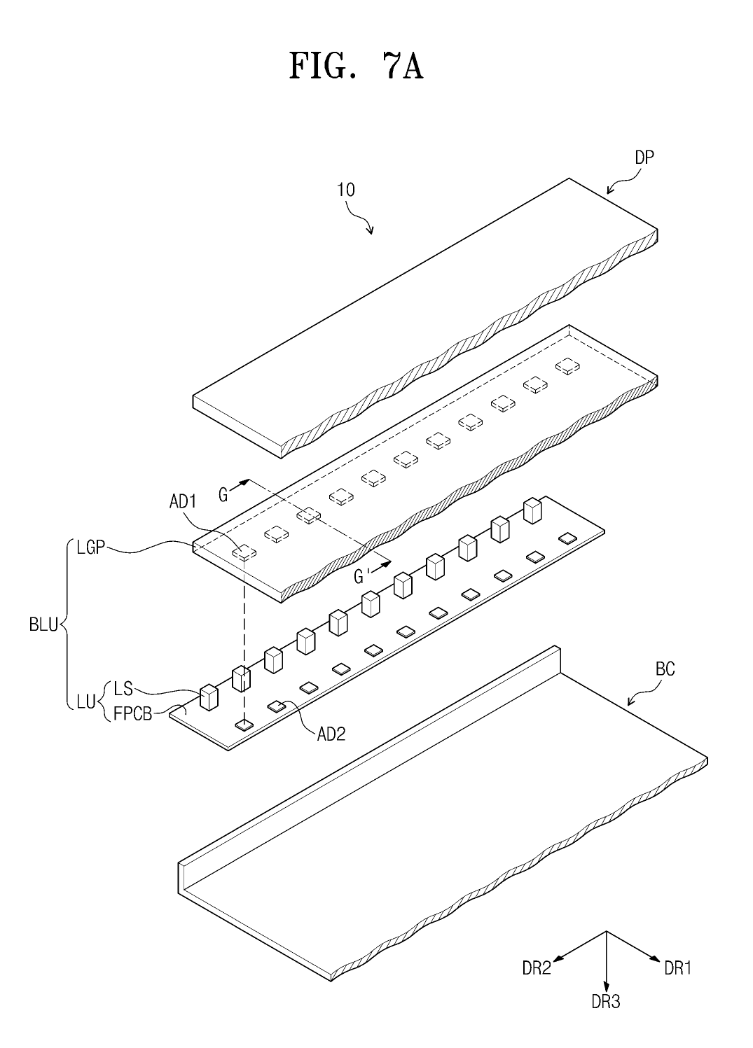

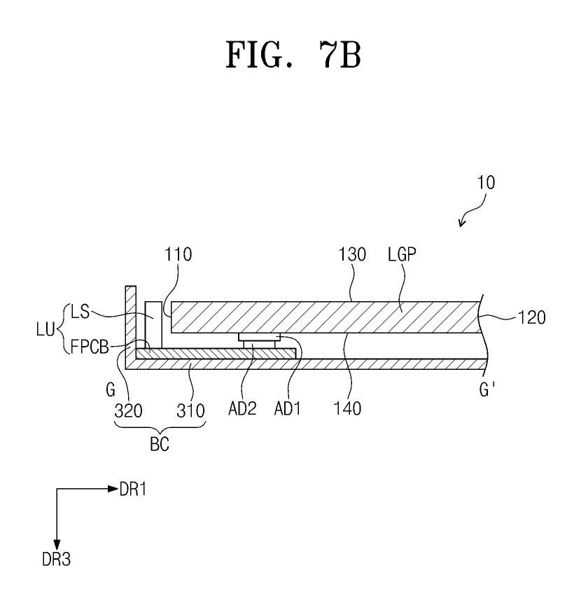

FIG. 7A is a perspective view showing a display device 10 according to an exemplary embodiment of the invention, and FIG. 7B is a cross-sectional view taken along line G-G′ shown in FIG. 7A.

Referring to FIGS. 7A and 7B, the display device 10 may further include a bottom chassis BC. The bottom chassis BC may include a metal material, and in detail, the bottom chassis BC may include the metal material having the magnetic force.

The bottom chassis BC includes a first sub-chassis part 310 and a second sub-chassis part 320. The flexible printed circuit board FPCB and the light guide plate LGP are placed on the first sub-chassis part 310. The flexible printed circuit board FPCB contacts the first sub-chassis part 310. The light guide plate LGP is spaced apart from the first sub-chassis part 310. In this case, a reflective member (not shown) may be disposed between the light guide plate LGP and the first sub-chassis part 310, and the reflective member (not shown) contacts the first sub-chassis part 310.

The second sub-chassis part 320 extends from the first sub-chassis part 310. The second sub-chassis part 320 extends from the first sub-chassis part 310 in the perpendicular direction. The first sub-chassis part 310 and the second sub-chassis part 320 are integrally connected to each other as a single unitary structure. The light guide plate LGP is spaced apart from the second sub-chassis part 320 in the first direction DR1. The light source LS is disposed between the light guide plate LGP and the second sub-chassis part 320. The second sub-chassis part 320, the light source LS, and the light guide plate LGP are spaced apart from each other in the first direction DR1. The second sub-chassis part 320 covers the light source LS. The second sub-chassis part 320 faces the light incident surface 110 of the light guide plate LGP. The bottom chassis BC has an L-shape in a cross-section.

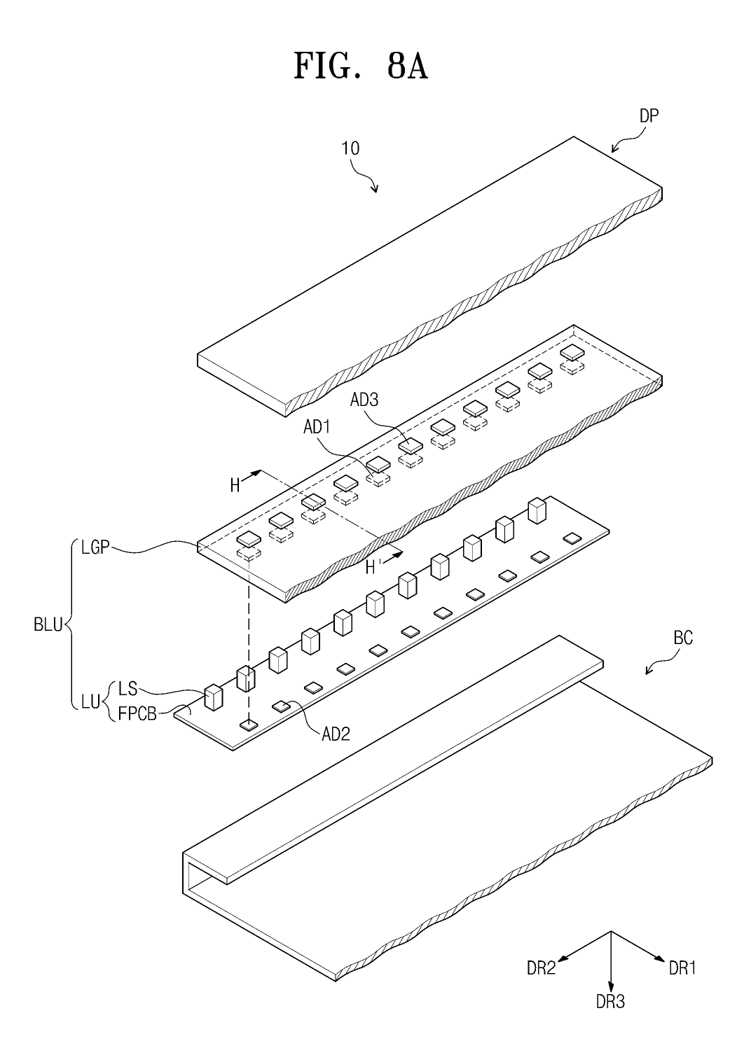

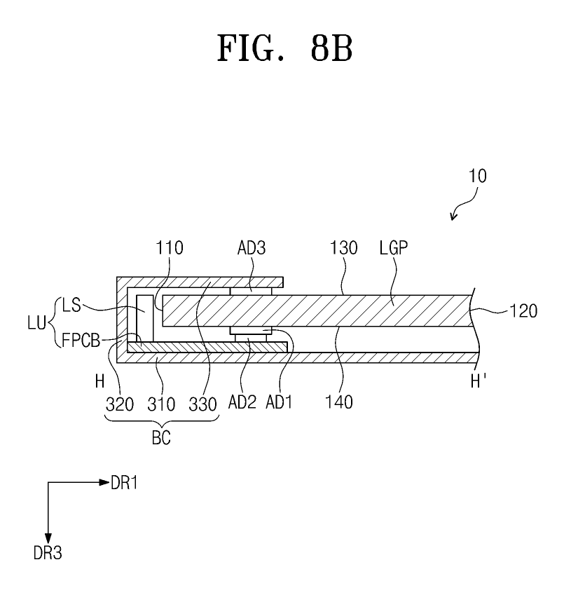

FIG. 8A is a perspective view showing a display device 10 according to an exemplary embodiment of the invention, and FIG. 8B is a cross-sectional view taken along line H-H′ shown in FIG. 8A.

Referring to FIGS. 8A and 8B, the display device 10 according to the exemplary embodiment may further include a third coupling member AD3. The third coupling member AD3 is disposed on a portion of the light exit surface 130. In this case, a bottom chassis BC may further include a third sub-chassis part 330. The third sub-chassis part 330 extends from the second sub-chassis part 320. The third sub-chassis part 330 is substantially parallel to a portion of the first sub-chassis part 310. The third sub-chassis part 330 overlaps a portion of the light guide plate LGP in a plan view. The bottom chassis BC has a laid U-shape in a cross-section. The third coupling member AD3 and the third sub-chassis part 330 are coupled to each other by the magnetic force. Thus, the light source unit LU and the light guide plate LGP may be more efficiently held, so that the misalignment between the light source unit LU and the light guide plate LGP may be prevented.

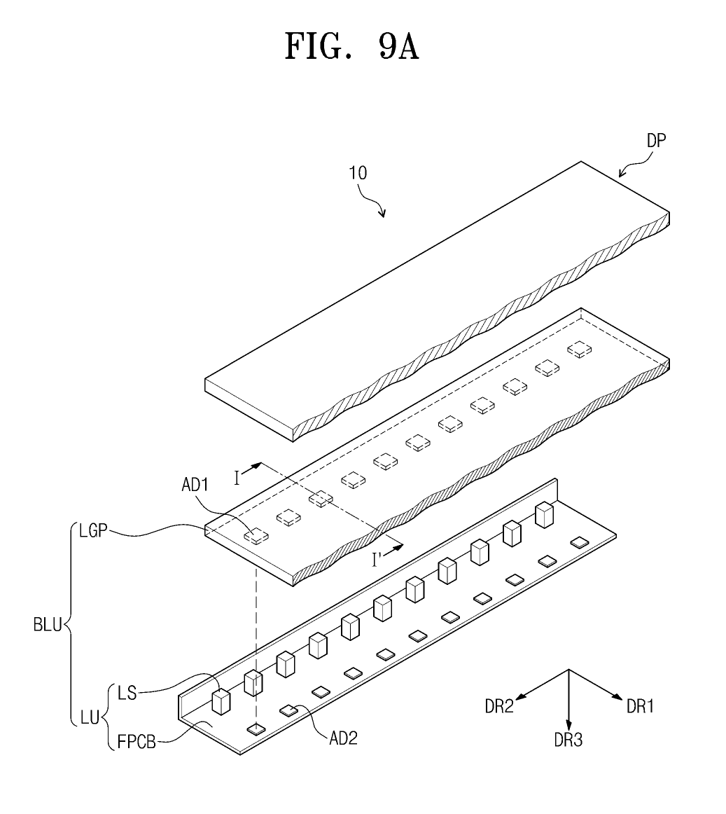

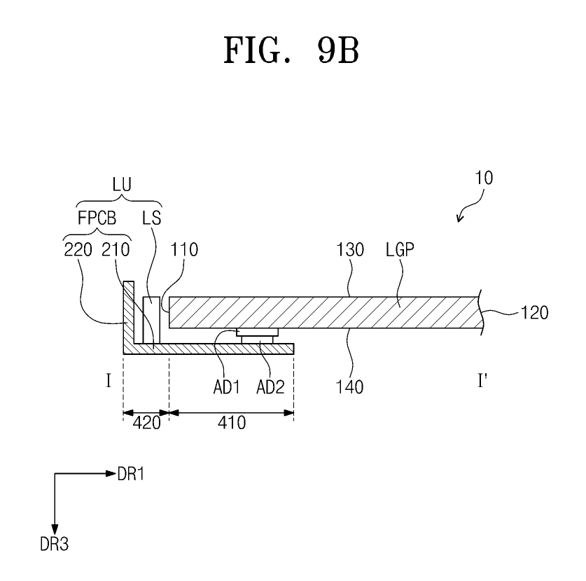

FIG. 9A is a perspective view showing a display device 10 according to an exemplary embodiment of the invention, and FIG. 9B is a cross-sectional view taken along line I-I′ shown in FIG. 9A.

Referring to FIGS. 9A and 9B, the flexible printed circuit board FPCB includes the first sub-board part 210 and the second sub-board part 220. The light source LS and the second coupling member AD2 are disposed on the first sub-board part 210 and spaced apart from each other. The first sub-board part 210 includes a first area 410 overlapping the light guide plate LGP and a second area 420 non-overlapping the light guide plate LGP in a plan view. The first area 410 and the second area 420 are integrally connected to each other as a single unitary structure. The second coupling member AD2 is disposed in the first area 410. The second coupling member AD2 is disposed in the first area 410 and below the light exit rear surface 140. The light source LS is disposed in the second area 420.

The second sub-board part 220 extends from the first sub-board part 210. The second sub-board part 220 extends from the first sub-board part 210 in the perpendicular direction. The light guide plate LGP is spaced apart from the second sub-board part 220 in the first direction DR1. The light source LS is disposed between the light guide plate LGP and the second sub-board part 220. The second sub-board part 220, the light source LS, and the light guide plate LGP are spaced apart from each other in the first direction DR1. The second sub-board part 220 faces the light incident surface 110. The flexible printed circuit board FPCB has an L-shape.

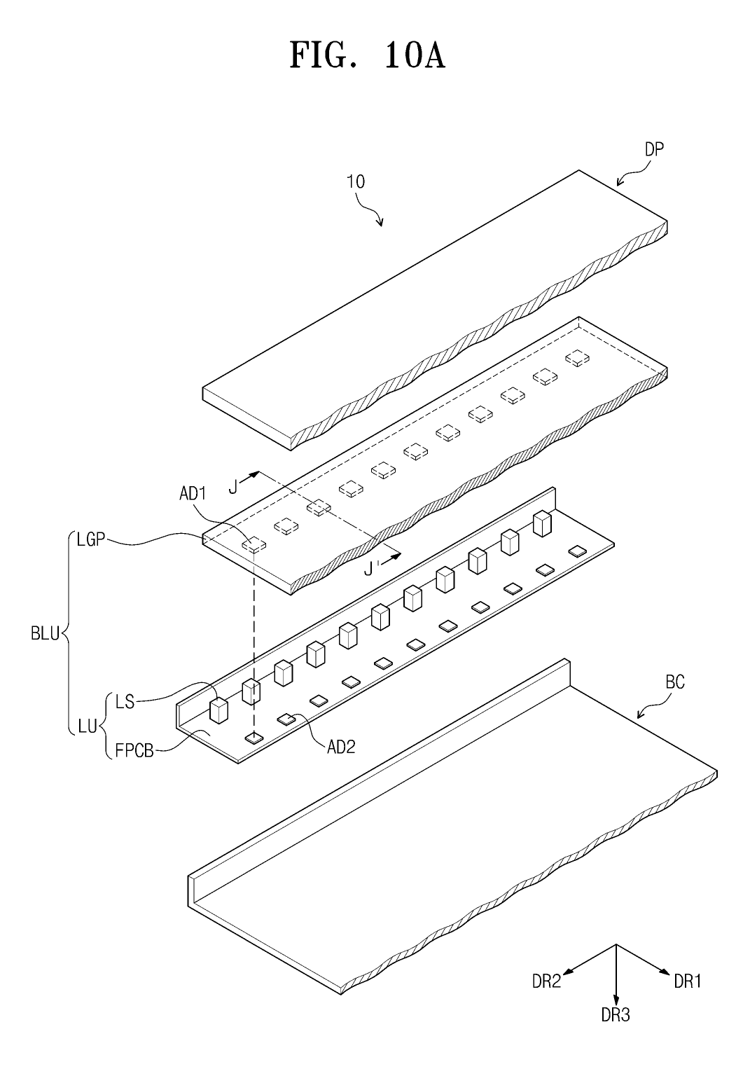

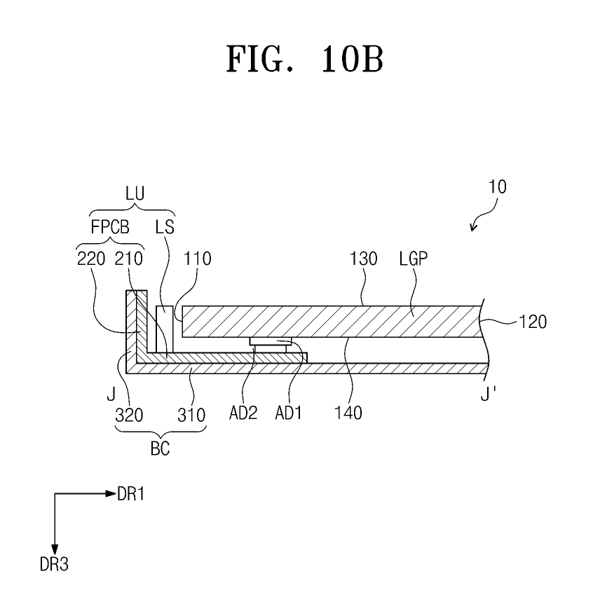

FIG. 10A is a perspective view showing a display device 10 according to an exemplary embodiment of the invention, and FIG. 10B is a cross-sectional view taken along line J-J′ shown in FIG. 10A.

Referring to FIGS. 10A and 10B, the display device 10 may further include a bottom chassis BC. The bottom chassis BC includes a first sub-chassis part 310 and a second sub-chassis part 320. The first sub-board part 210 and the light guide plate LGP are placed on the first sub-chassis part 310. The first sub-board part 210 contacts the first sub-chassis part 310. The light guide plate LGP may be spaced apart from the first sub-chassis part 310. In this case, a reflective member (not shown) may be disposed between the light guide plate LGP and the first sub-chassis part 310, and the reflective member (not shown) contacts the first sub-chassis part 310.

The second sub-chassis part 320 extends from the first sub-chassis part 310. The second sub-chassis part 320 extends from the first sub-chassis part 310 in the perpendicular direction. The first sub-chassis part 310 and the second sub-chassis part 320 are integrally connected to each other as a single unitary structure. The light guide plate LGP is spaced apart from the second sub-chassis part 320 in the first direction DR1. The light source LS is disposed between the light guide plate LGP and the second sub-chassis part 320. The second sub-chassis part 320, the light source LS, and the light guide plate LGP are spaced apart from each other in the first direction DR1. The second sub-chassis part 320 contacts the second sub-board part 220. The second sub-chassis part 320 faces the light incident surface 110 of the light guide plate LGP. The bottom chassis BC has an L-shape in a cross-section.

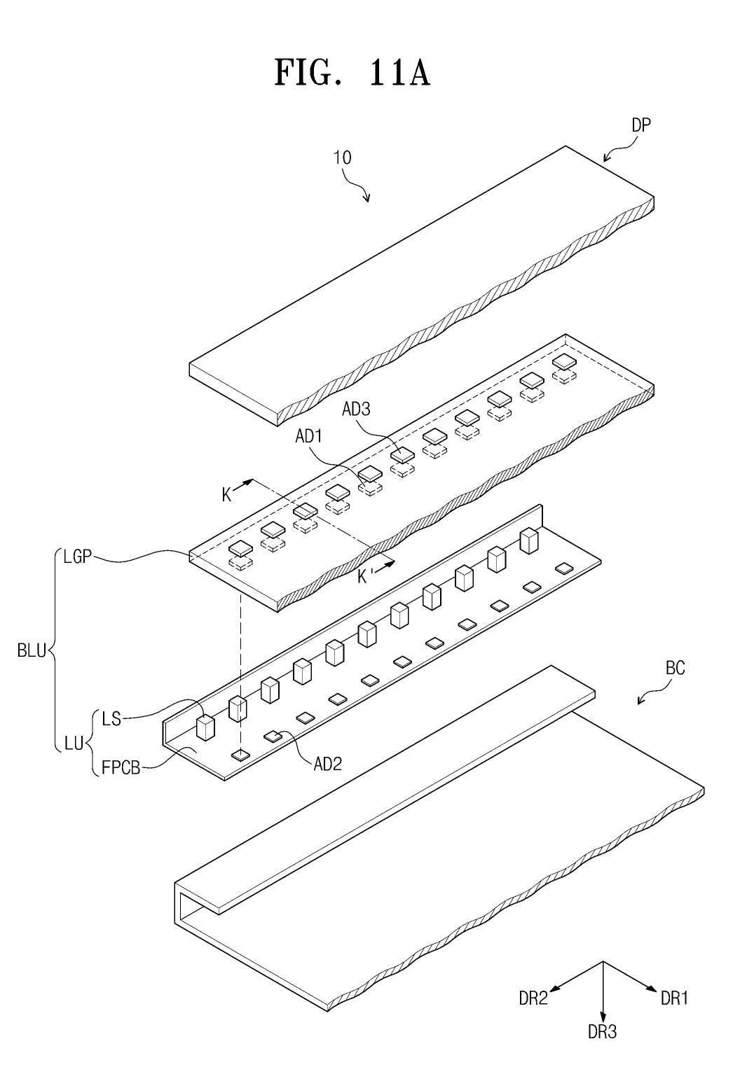

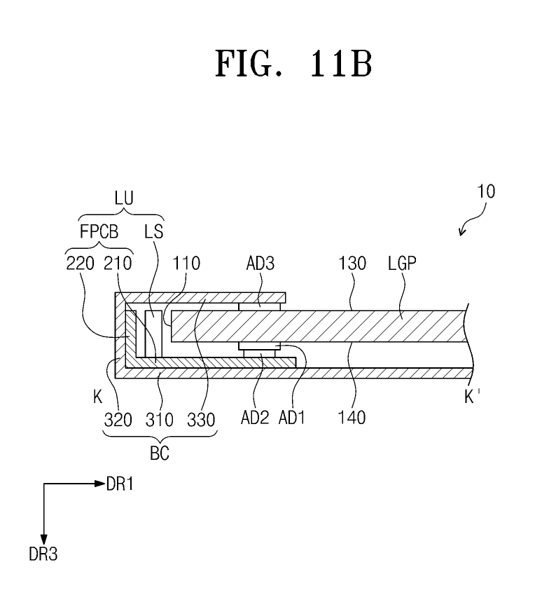

FIG. 11A is a perspective view showing a display device 10 according to an exemplary embodiment of the invention, and FIG. 11B is a cross-sectional view taken along line K-K′ shown in FIG. 11A.

Referring to FIGS. 11A and 11B, the display device 10 according to the exemplary embodiment may further include a third coupling member AD3. The third coupling member AD3 is disposed on a portion of the light exit surface 130. In this case, a bottom chassis BC may further include a third sub-chassis part 330. The third sub-chassis part 330 extends from the second sub-chassis part 320. The third sub-chassis part 330 is substantially parallel to a portion of the first sub-chassis part 310. The third sub-chassis part 330 overlaps a portion of the light guide plate LGP in a plan view. The bottom chassis BC has a laid U-shape in a cross-section. The third coupling member AD3 and the third sub-chassis part 330 are coupled to each other by the magnetic force. Thus, the light source unit LU and the light guide plate LGP may be more efficiently held, so that the misalignment between the light source unit LU and the light guide plate LGP may be prevented. The flexible printed circuit board FPCB of the FIGS. 8A and 8B has an L-shape in a cross-section, while the flexible printed circuit board FPCB of the FIGS. 11A and 11B has a laid U-shape in a cross-section.

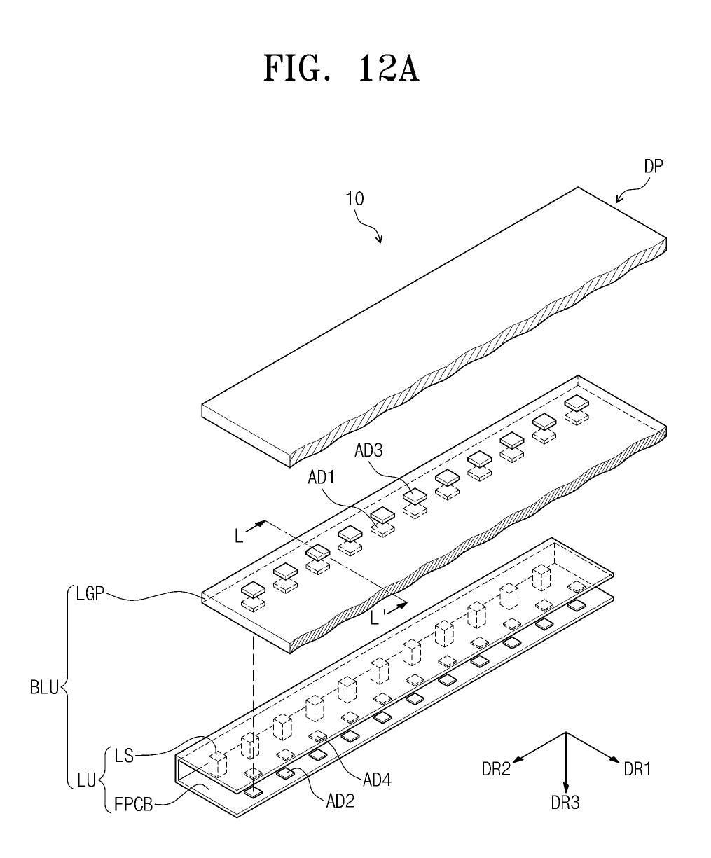

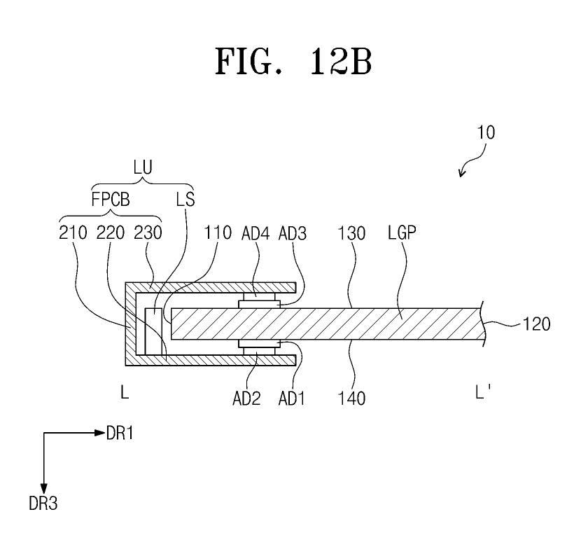

FIG. 12A is a perspective view showing a display device 10 according to an exemplary embodiment of the invention, and FIG. 12B is a cross-sectional view taken along line L-L′ shown in FIG. 12A.

Referring to FIGS. 12A and 12B, the flexible printed circuit board FPCB may further include the third sub-board part 230 in addition to the first and second sub-board parts 210 and 220. The third sub-board part 230 extends from the second sub-board part 220. The third sub-board part 230 extends from the second sub-board part 220 in the first direction DR1. The first and third sub-board parts 210 and 230 are substantially parallel to each other. The first and third sub-board parts 210 and 230 overlap each other in a plan view. The first sub-board part 210 has a width, e.g., a length in the first direction DR1, substantially equal to or different from a width, e.g., a length in the first direction DR1, of the third sub-board part 230. In the exemplary embodiment, the display device 10 may further include a fourth coupling member AD4 contacting the third sub-board part 230.

As described above, the first coupling member AD1 may partially overlap or may be spaced apart from the third coupling member AD3 in a plan view.

The display device 10 according to the exemplary embodiment may further include a third coupling member AD3 disposed on a portion of the light exit surface 130, and the third and fourth coupling members AD3 and AD4 are coupled to each other by the magnetic force. Accordingly, the light source unit LU and the light guide plate LGP may be more efficiently held, and thus the misalignment between the light source unit LU and the light guide plate LGP may be prevented.

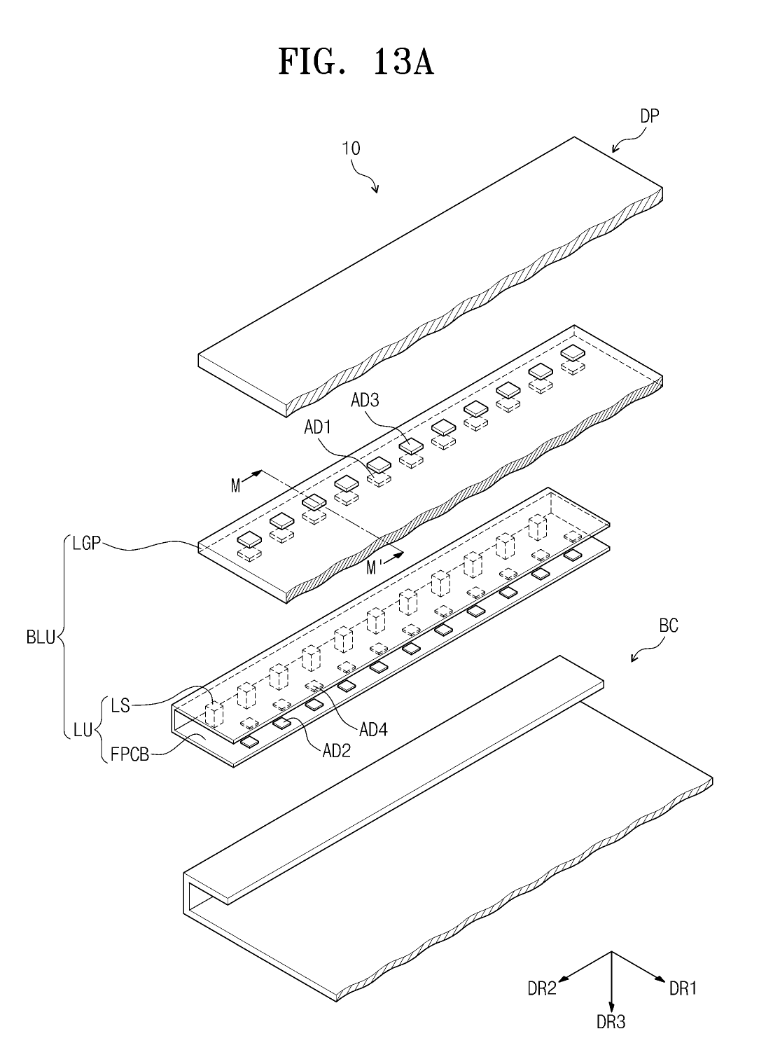

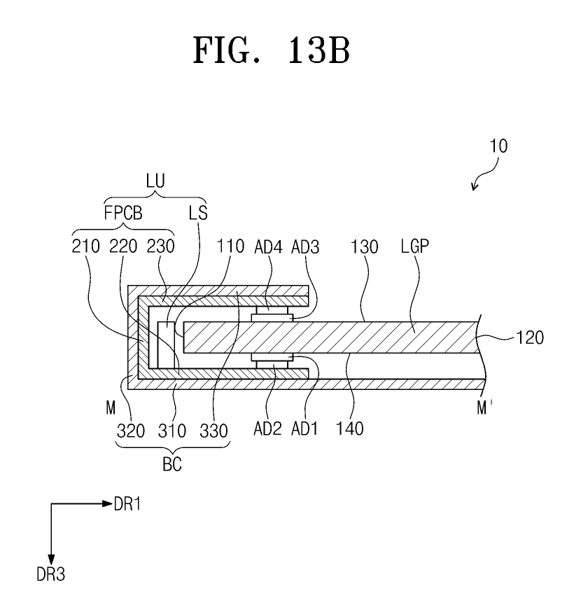

FIG. 13A is a perspective view showing a display device 10 according to an exemplary embodiment of the invention, and FIG. 13B is a cross-sectional view taken along line M-M′ shown in FIG. 13A.

Referring to FIGS. 13A and 13B, the display device 10 may further include a bottom chassis BC. The bottom chassis BC includes first, second, and third sub-chassis parts 310, 320, and 330. The first sub-board part 210 and the light guide plate LGP are placed on the first sub-board part 210. The first sub-board part 210 contacts the first sub-chassis part 310. The light guide plate LGP is spaced apart from the first sub-chassis portion 310.

The second sub-chassis part 320 extends from the first sub-chassis part 310. The second sub-chassis part 320 extends from the first sub-chassis part 310 in the perpendicular direction.

The third sub-chassis part 330 extends from the second sub-chassis part 320. The third sub-chassis part 330 extends from the second sub-chassis part 320 in the first direction DR1. The third sub-chassis part 330 is substantially parallel to a portion of the first sub-chassis part 310. The third sub-chassis part 330 overlaps a portion of the first sub-chassis part 310 in a plan view. In the case where the bottom chassis BC further includes the third sub-chassis part 330, the first sub-chassis part 310 is divided into an area overlapping the third sub-chassis part 330 and an area non-overlapping the third sub-chassis part 330 in a plan view, and the two areas are adjacent to each other. In the case where the bottom chassis BC further includes the third sub-chassis part 330, the bottom chassis BC has a laid U-shape in a cross-section. The first, second, and third sub-chassis parts 310, 320, and 330 are integrally connected to each other as a single unitary structure.

As shown in FIGS. 13A and 13B, the first and second coupling members AD1 and AD2 are securely coupled to each other by the magnetic force, and the third and fourth coupling members AD3 and AD4 are securely coupled to each other by the magnetic force. In addition, since the bottom chassis securely holds the light source unit LU and the light guide plate LGP, which are fixed to each other by the first to fourth coupling members AD1 to AD4, the light source unit LU and the light guide plate LGP may more effectively be prevented from being misaligned with each other.

In FIGS. 1A to 13B, the light guide plate LGP has a uniform thickness, but it should not be limited thereto or thereby. For instance, the thickness of the light guide plate LGP may be decreased as a distance from the light incident surface 110 increases, or the light guide plate LGP may have a tapered shape. In the case where the light guide plate LGP has the tapered shape, the first coupling member AD1 is preferred to be placed under a portion neighboring to the light incident surface 110 with respect to an inclination surface. In the case where the third coupling member AD3 is further provided, the third coupling member AD3 may be placed on a portion neighboring to the light incident surface 110 with respect to the inclination surface.

Although not shown in figures, the flexible printed circuit board FPCB may include a flexible resin layer and a power source line disposed on the resin layer. The flexible printed circuit board FPCB may further include an insulating layer. The insulating layer covers and insulates the power source line from external environment. The second coupling member AD2 includes the material having the magnetic force and exerts influences on the power source line, and thus the power source line may not be disposed on a portion of the flexible printed circuit board FPCB, in which the second coupling member AD2 is disposed. The flexible printed circuit board FPCB includes an area in which the power source line is disposed and an area in which the power source line is not disposed, the light source LS is provided to the area in which the power source line is disposed, and the second coupling member AD2 is provided to the area, in which the power source line is not disposed, to be spaced apart from the light source LS.

According to the display device, the first coupling member is disposed on the portion of the light guide plate, and the second coupling member securely coupled to the first coupling member by the magnetic force is disposed on the flexible printed circuit board. Therefore, the light guide plate and light source unit may be prevented from being misaligned with each other. The display device may further include the third coupling member disposed on the portion of the light guide plate to be spaced apart from the first coupling member, and in this case, the fourth coupling member securely coupled to the third coupling member by the magnetic force is disposed on the portion of the flexible printed circuit board. Thus, the light guide plate and light source unit may be more effectively prevented from being misaligned with each other. In addition, the display device may further include the bottom chassis, and the light guide plate and the light source unit, which are fixed by the first and second coupling members, may be more securely fixed by the bottom chassis. As a result, the light guide plate and the light source unit may be prevented from being misaligned with each other.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A display device comprising:
a backlight unit; and
a display panel disposed above the backlight unit, the backlight unit comprising:
a light guide plate comprising a light incident surface, an opposite surface facing the light incident surface, a light exit surface connecting the light incident surface and the opposite surface, and a light exit rear surface facing the light exit surface;
a light source unit comprising a light source facing the light incident surface and a flexible printed circuit board disposed on a surface of the light source;
a first coupling member disposed on a portion of the light exit rear surface; and
a second coupling member disposed on a portion of the flexible printed circuit board, wherein the first coupling member and the second coupling member are coupled to each other by a magnetic force.

2. The display device of claim 1, wherein one member of the first and second coupling members includes a magnet, and the other member of the first and second coupling members includes one of a magnet and a magnetic metal.

3. The display device of claim 2, wherein the magnetic metal comprises at least one of nickel, iron, cobalt, palladium, and an alloy thereof.

4. The display device of claim 1, wherein the flexible printed circuit board comprises:
a first sub-board part disposed under the light exit rear surface; and
a second sub-board part extending from the first sub-board part and facing the light incident surface,
wherein the second coupling member is disposed on the first sub-board part, and the light source contacts the second sub-board part.

5. The display device of claim 4, further comprising a bottom chassis comprising a metal material, wherein the bottom chassis comprises:
a first sub-chassis part on which the first sub-board part and the light guide plate are placed; and
a second sub-chassis part extending from the first sub-chassis part and contacting the second sub-board part.

6. The display device of claim 5, further comprising a third sub-chassis part extending from the second sub-chassis part and facing a portion of the first sub-chassis part.

7. The display device of claim 1, further comprising a third coupling member disposed on a portion of the light exit surface.

8. The display device of claim 7, wherein the first and third coupling members partially overlap each other in a plan view.

9. The display device of claim 7, wherein the first and third coupling members are spaced apart from each other in a plan view.

10. The display device of claim 7, further comprising a fourth coupling member disposed on an opposite portion of the flexible printed circuit board opposite to the portion of the flexible printed circuit board and spaced apart from the second coupling member, wherein the third and fourth coupling members are coupled to each other by a magnetic force.

11. The display device of claim 10, wherein the flexible printed circuit board comprises:
a first sub-board part disposed under the light exit rear surface;
a second sub-board part extending from the first sub-board part and facing the light incident surface; and
a third sub-board part extending from the second sub-board part and facing a portion of the first sub-board part, the second coupling member is disposed on the first sub-board part, the light source contacts the second sub-board part, and the fourth coupling member contacts the third sub-board part.

12. The display device of claim 11, further comprising a bottom chassis comprising a metal material, wherein the bottom chassis comprises:
a first sub-chassis part on which the first sub-board and the light guide plate are disposed;
a second sub-chassis part extending from the first sub-chassis part and contacting the second sub-board part; and
a third sub-chassis part extending from the second sub-chassis part and facing a portion of the first sub-chassis part.

13. The display device of claim 1, wherein the flexible printed circuit board comprises:
a first area overlapping the light guide plate in a plan view; and
a second area non-overlapping with the light guide plate in the plan view, the second coupling member is disposed in the first area, and the light source is disposed in the second area.

14. The display device of claim 13, further comprising a bottom chassis comprising a metal material, wherein the bottom chassis comprises:
a first sub-chassis part on which the flexible printed circuit board and the light guide plate are placed; and
a second sub-chassis part extending from the first sub-chassis part to cover the light source.

15. The display device of claim 14, further comprising a third coupling member disposed on a portion of the light exit surface, wherein the bottom chassis further comprises a third sub-chassis part extending from the second sub-chassis part and facing a portion of the first sub-chassis part, and the third coupling member and the third sub-chassis part are coupled to each other by a magnetic force.

16. The display device of claim 1, wherein the flexible printed circuit board comprises:
a first sub-board part disposed under the light exit rear surface; and
a second sub-board part extending from the first sub-board part and facing the light incident surface, the first sub-board part comprises:
a first area overlapping the light guide plate in a plan view; and
a second area non-overlapping the light guide plate in the plan view, the second coupling member is disposed in the first area, and the light source is disposed in the second area.

17. The display device of claim 16, further comprising a bottom chassis comprising a metal material, wherein the bottom chassis comprises:
a first sub-chassis part on which the first sub-board part and the light guide plate are placed; and
a second sub-chassis part extending from the first sub-chassis part and contacting the second sub-board part.

18. The display device of claim 17, further comprising a third coupling member disposed on a portion of the light exit surface, wherein the bottom chassis further comprises a third sub-chassis part extending from the second sub-chassis part and facing a portion of the first sub-chassis part, and the third coupling member and the third sub-chassis part are coupled to each other by a magnetic force.

19. The display device of claim 16, wherein the flexible printed circuit board further comprises a third sub-board part extending from the second sub-board part and facing a portion of the first sub-board part.

20. The display device of claim 19, further comprising:
a third coupling member disposed on a portion of the light exit surface; and
a fourth coupling member contacting the third sub-board part, wherein the third and fourth coupling members are coupled to each other by a magnetic force.
